(19) United States
(12) Patent Application Publication
(10) Pub. No.: US 2025/0010190 A1
(43) Pub. Date: Jan. 9, 2025

(54) NON-TRANSITORY STORAGE MEDIUM HAVING STORED THEREIN INFORMATION PROCESSING PROGRAM, INFORMATION PROCESSING DEVICE, INFORMATION PROCESSING METHOD, AND INFORMATION PROCESSING SYSTEM

(71) Applicant: Nintendo Co., Ltd., Kyoto (JP)

(72) Inventors: Ryuichi NAKADA, Kyoto (JP); Akira KINASHI, Kyoto (JP); Shinzi WATANABE, Tokyo (JP); Ryosuke AGAWA, Tokyo (JP)

(21) Appl. No.: 18/658,306

(22) Filed: May 8, 2024

(30) Foreign Application Priority Data
Jul. 4, 2023 (JP) 2023-110298

(51) Int. Cl. A63F 13/5378; A63F 13/35; A63F 13/5372; A63F 13/69

(52) U.S. Cl. CPC A63F 13/5378; A63F 13/35; A63F 13/69; A63F 13/5372

(57) ABSTRACT

The game device (2) functions as a first terminal capable of executing a game in which the game status is synchronized with a second terminal participating in the same session. The game device (2) controls a location of first character in virtual space in the game based on first operation input by first user of the first terminal, stores location history information in a memory unit (45) indicating where each of the first character and a second character of the second terminal has been positioned in the virtual space in the game, and presents a map image when there is a log screen display operation from the first user, distinguishable between a person's traversed area and an other's traversed area, based on the location history information.

### CROSS REFERENCE TO RELATED APPLICATION

This nonprovisional application is based on Japanese Patent Application No. 2023-110298 filed with the Japan Patent Office on Jul. 4, 2023, the entire contents of which are hereby incorporated by reference.

### FIELD

This disclosure relates to a non-transitory storage medium having stored therein an information processing program for executing a game, an information processing device, an information processing method, and an information processing system.

### BACKGROUND AND SUMMARY

There is known a system for acquiring a play record including positional information of each player character in a virtual space when a plurality of users play a game respectively, and displaying the in-game state of each player character on a display device based on the play record (see, for example, JP-2018-50866A). Such a system can present information on the position in the virtual space where the player characters of the own player character and those of other users are located respectively.

In a game in which a player character is moved in a virtual space, the system is known to present a map image of the virtual space to display the area where the player character has met predetermined conditions (e.g., areas where the player character is located, areas where the player character has performed predetermined actions such as coloring, areas where the player character has accomplished predetermined missions, etc.). By checking this map image, the user can easily confirm which area in the virtual space has met the predetermined condition.

The purpose of the present disclosure is to provide, for a game in which a player character moves in a virtual space, a novel non-transitory storage medium having stored therein information processing program, a novel information processing device, a novel information processing method, and a novel information processing system for presenting a map image in which the area where the player character has been located is visible.

In a non-transitory storage medium of configuration 1, an information processing program is stored therein. The information processing program is executed by a computer of a first terminal capable of executing a game in which a game status is synchronized with a second terminal participating in a same session. The information processing program causes the computer to function as: a controller configured to control a location of a first character in a virtual space in the game based on a first operation input by a first user of the first terminal; a location history information storing section configured to store in a memory unit location history information indicating where each of a second character whose location in the virtual space is controlled based on an operation input by a second user of the second terminal and the first character has been located in the virtual space in the game; and a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

This configuration improves the visibility of the areas where the first character and the second characters have been located, respectively, since the map image is presented at the first terminal that enables recognition of areas where the first character has been located and areas where the second character of the second terminal has been located.

In the non-transitory storage medium of configuration 2, the information processing program according to that of the configuration 1 is stored therein. In the information processing program, the presentation section is configured to present the map image so that the first area is presented in a first display mode and the second area is presented in a second display mode, and to present the map image so that it is presented in the first display mode for areas where both the first character and the second character have been located.

This configuration improves the visibility of the areas where the first character and the second character have been located respectively, since the areas where the first character has been located and the areas where the second character of the second terminal has been located are displayed in different display modes from each other.

In the non-transitory storage medium of configuration 3, an information processing program according to that of the configuration 1 or 2 is stored therein. The information processing program further causes the computer to function as: a notification presenting section configured to present a notification to a first user of the first character and a second user of the second character, when a parameter indicating a size of an area in the virtual space in which the first character and the second character have been located in the virtual space meets a predetermined condition.

This configuration allows the user to grasp the size of the area where the first character and the second character have been located in the virtual space.

In the non-transitory storage medium of configuration 4, the information processing program according to that of any of the configurations 1 to 3 is stored therein. In the information processing program, the presentation section is configured to mask areas in the virtual space where the first character has not been located, and to reveal areas in the virtual space where the first character has been located by removing masks in areas in the virtual space where the first character has been located.

This configuration limits the presentation of map images of areas in the virtual space where the first character has never been located, thereby improving the entertainment value of games that explore such areas.

In the non-transitory storage medium of configuration 5, the information processing program according to that of the configuration 4 is stored therein. In the information processing program, the presentation section is configured to mask areas in the virtual space where the first character has not been located with different masks for a third area where the second character has been located and a fourth area where the second character has not been located.

This configuration makes it possible to distinguish between areas where either of the other characters has ever been located and areas where neither of the other characters has ever been located.

In the non-transitory storage medium of configuration 6, the information processing program according to that of the configuration 5 is stored therein. In the information processing program, the presentation section is configured to perform a first mask that reduce color information of ground surface in the third area and a second mask that superimposes a mask panel that hides ground surface in the fourth area.

In this configuration, the ground surface is not presented for areas where no character has ever been located, and presents the ground surface with less color information for areas where other characters have been located, thereby allowing the user to distinguish between the two areas and improving the entertainment value of games that explore areas where no character has ever been located.

In a non-transitory storage medium of configuration 7, the information processing program executed by a computer of a terminal capable of executing a game is stored therein. The information processing program causes the computer to function as: a controller configured to control a location of a first character in a virtual space based on a first operation input by a user of the terminal; a location history information storing section configured to store location history information indicating location of the first character in the virtual space at each time interval in a memory unit; and a presentation section configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

This configuration makes it easy to identify where in the virtual space the first character has been located during the period from the presentation of the previous map image to the presentation of the current map image.

In the non-transitory storage medium of configuration 8, the information processing program according to that of the configuration 7 is stored therein. The information processing program further causes the computer to function as: a synchronization section configured to synchronize a game status with other terminals participating in a same session, wherein the location history information includes information indicating a location in the virtual space at each different time for the second character of the other terminals.

This configuration also makes it possible to present a map image showing where the second character has been in the virtual space during the period from the presentation of the previous map image to the presentation of the current map image.

In the non-transitory storage medium of configuration 9, the information processing program according to that of the configuration 8 is stored therein. In the information processing program, the presentation section is configured to present the map image in a manner that enables distinguishing, based on the location history information, between a first area where the first character has been located and a second area where the second character has been located.

This configuration improves visibility because the map image is presented in such a way that it is possible to distinguish between the area where the first character has been located and the area where the second character has been located.

In the non-transitory storage medium of configuration 10, the information processing program according to that of any of the configuration 7 to 9 is stored therein. In the information processing program the presentation section is configured to present the map image such that after presenting the previous map image, the current map image is presented progressively.

This configuration allows the user to see the newly located area between the presentation of the previous map image and the presentation of the current map image in an animated manner.

In the non-transitory storage medium of configuration 11, the information processing program according to that of the configuration 10 is stored therein. In the information processing program, the presentation section is configured to present the map image masked to areas where the first character has not been located based on the location history information, and to shift the masked image to the current map image by progressively unmasking the previous map image, for areas where the first character has been newly positioned during the period between a previous second operation input and a current second operation input, based on the location history information.

This configuration allows the user to see the newly located areas between the presentation of the previous map image and the presentation of the current map image with the unmasking animation.

An information processing device of configuration 12 is as a first terminal capable of executing a game in which a game status is synchronized with a second terminal participating in a same session. The information processing device comprises: a controller configured to control a location of a first character in a virtual space in the game based on a first operation input by a first user of the first terminal; a location history information storing section configured to store in a memory unit location history information indicating where each of a second character whose location in the virtual space is controlled based on an operation input by a second user of the second terminal and the first character has been located in the virtual space in the game; and a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

This configuration improves the visibility of the areas where the first character and the second characters have been located, respectively, since the map image is presented at the first terminal that enables recognition of areas where the first character has been located and areas where the second character of the second terminal has been located.

An information processing device of configuration 13 is information processing device provided on a terminal capable of executing a game. The information processing device comprises: a controller configured to control a location of a first character in a virtual space based on a first operation input by a user of the terminal; a location history information storing section configured to store location history information indicating location of the first character in the virtual space at each time interval in a memory unit; and a presentation section configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

This configuration makes it easy to identify where in the virtual space the first character has been located during the period from the presentation of the previous map image to the presentation of the current map image.

An information processing method of configuration 14 is executed by a first terminal capable of executing a game in which a game status is synchronized with a second terminal participating in a same session. The information processing method comprises: a control step configured to control a location of a first character in a virtual space in the game based on a first operation input by a first user of the first terminal; a location history information storing step configured to store in a memory unit location history information indicating where each of a second character whose location in the virtual space is controlled based on an operation input by a second user of the second terminal and the first character has been located in the virtual space in the game; and a presentation step configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

This configuration improves the visibility of the areas where the first character and the second characters have been located, respectively, since the map image is presented at the first terminal that enables recognition of areas where the first character has been located and areas where the second character of the second terminal has been located.

In the information processing method of configuration 15 according to the configuration 14, the presenting step is configured to present the map image so that the first area is presented in a first display mode and the second area is presented in a second display mode, and to present the map image so that it is presented in the first display mode for areas where both the first character and the second character have been located.

This configuration improves the visibility of the areas where the first character and the second character have been located respectively, since the areas where the first character has been located and the areas where the second character of the second terminal has been located are displayed in different display modes from each other.

The information processing method of configuration 16 according to the configuration 14 or 15, further comprises: a notification presenting step configured to present a notification to a first user of the first character and a second user of the second character, when a parameter indicating a size of an area in the virtual space in which the first character and the second character have been located in the virtual space meets a predetermined condition.

This configuration allows the user to grasp the size of the area where the first character and the second character have been located in the virtual space.

In the information processing method of configuration 17 according to any of the configurations 14 to 16, the presenting step is configured to mask areas in the virtual space where the first character has not been located, and to reveal areas in the virtual space where the first character has been located by removing masks in areas in the virtual space where the first character has been located.

This configuration limits the presentation of map images of areas in the virtual space where the first character has never been located, thereby improving the entertainment value of games that explore such areas.

An information processing method of configuration 18 is executed on a terminal capable of executing a game. The information processing method comprises: a first control step configured to control a location of a first character in a virtual space based on a first operation input by a user of the terminal; a location history information storing step configured to store location history information indicating location of the first character in the virtual space at each time interval in a memory unit; and a presentation step configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

This configuration makes it easy to identify where in the virtual space the first character has been located during the period from the presentation of the previous map image to the presentation of the current map image.

An information processing system of configuration 19 is capable of executing a game in which a game status is synchronized between a second terminal and a first terminal participating in a same session. The information processing system comprises: a controller configured to control a location of a first character in a virtual space in the game based on a first operation input by a first user of the first terminal; a location history information storing section configured to store in a memory unit location history information indicating where each of a second character whose location in the virtual space is controlled based on an operation input by a second user of the second terminal and the first character has been located in the virtual space in the game; and a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

This configuration improves the visibility of the areas where the first character and the second characters have been located, respectively, since the map image is presented at the first terminal that enables recognition of areas where the first character has been located and areas where the second character of the second terminal has been located.

An information processing system of configuration 20 includes a terminal capable of executing a game. The information processing system comprises: a controller configured to control a location of a character in a virtual space based on a first operation input by a user of the terminal; a location history information storing section configured to store location history information indicating location of the character in the virtual space at each time interval in a memory unit; and a presentation section configured to present a map image corresponding to the virtual space based on a second operation input by the user, wherein the map image is visible of locations where the character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

This configuration makes it easy to identify where in the virtual space the first character has been located during the period from the presentation of the previous map image to the presentation of the current map image.

The foregoing and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a schematic diagram showing the overall image of an information processing system in an embodiment of the present disclosure;

FIG. 2 is a block diagram showing the hardware configuration of a game server in the embodiment of the present disclosure;

FIG. 3 is a block diagram showing an example of the hardware configuration of a game device in the embodiment of the present disclosure;

FIG. 4 is a block diagram showing the functional configuration of the information processing system in the embodiment of the present disclosure;

FIG. 5 is a table showing the data structure of the location history information stored in the memory in the embodiment of the present disclosure;

FIG. 6 is a timing chart of the process performed for synchronization between the game server, the first terminal, and the second terminal in the embodiment of the present disclosure;

FIG. 7 shows an example of a game screen in the embodiment of the present disclosure;

FIG. 8 shows an example of a log screen in the embodiment of the present disclosure;

FIG. 9 shows another example of a map image in the embodiment of the present disclosure;

FIG. 10A shows an example of the display of a mark indicating the position of a player character in a map image in the embodiment of the present disclosure;

FIG. 10B shows an example of displaying a mark indicating the position of a player character in a map image in the embodiment of the present disclosure;

FIG. 10C shows an example of the display of a mark indicating the position of a player character in a map image in the embodiment of the present disclosure;

FIG. 11 shows an example of a map image in the embodiment of the present disclosure;

FIG. 12 shows an example of a map image in the embodiment of the present disclosure;

FIG. 13A shows an example of a map image in the embodiment of the present disclosure;

FIG. 13B shows an example of a map image in the embodiment of the present disclosure;

FIG. 13C shows an example of a map image in the embodiment of the present disclosure;

FIG. 14 shows an example of a portion of a map image in the embodiment of the present disclosure;

FIG. 15 is a flowchart of the screen presentation process in the embodiment of the present disclosure; and

FIG. 16 shows an example of an un-unveiled distribution map image in the embodiment of the present disclosure.

### DETAILED DESCRIPTION OF NON-LIMITING EXAMPLE EMBODIMENTS

The following is a description of a non-transitory storage medium having stored therein an information processing program, an information processing device, an information processing method, and an information processing system in the embodiment of the present disclosure, with reference to the drawings. The embodiments described below are examples of cases in which the disclosure is implemented, and are not limited to the specific configuration described below. In implementing the disclosure, specific configurations according to the embodiments may be adopted as appropriate.

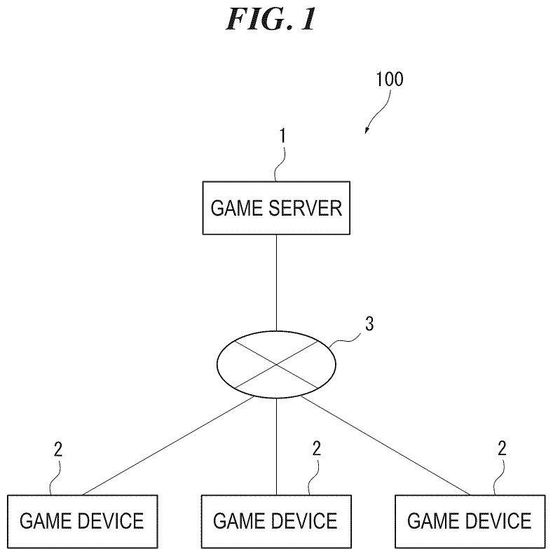

FIG. 1 is a schematic diagram showing the overall image of an information processing system in the embodiment of the present disclosure. The information processing system 100 includes a server 1 and a plurality of information processing devices 2. In this embodiment, the information processing system 100 is applied as a game system, where the server 1 is a game server and the information processing devices 2 is a game device. The information processing device as the game device 2 may be a dedicated game device or may comprise a general-purpose information processing apparatus such as a smartphone, stationary or portable game apparatus, tablet terminal, cell phone, personal computer, wearable terminal, etc. executing a game program. The game server 1 and the game devices 2 are configured to capable of communicating with each other via a network 3 such as the Internet. In the following embodiments, a person who uses the information processing system, i.e., a person who plays a game, is called a user, and a character operated by the user in the game is called a player character.

### [Hardware Configuration of the Game Server]

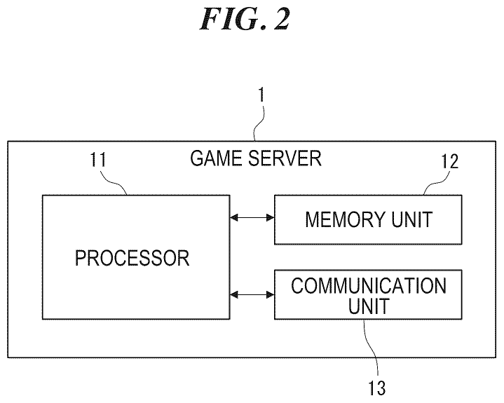

FIG. 2 is a block diagram showing the hardware configuration of a game server in the embodiment of the present disclosure. The game server 1 includes at least a processor 11, a memory unit 12, and a communication unit 13. The processor 11 executes various programs to control the game server 1. The memory unit 12 stores various programs executed and various data used by the processor 11. The communication unit 13 connects to the network 3 by wired or wireless communication and transmits and receives predetermined data to and from the game device 2 or other servers (not shown).

### [Hardware Configuration of a Game Device]

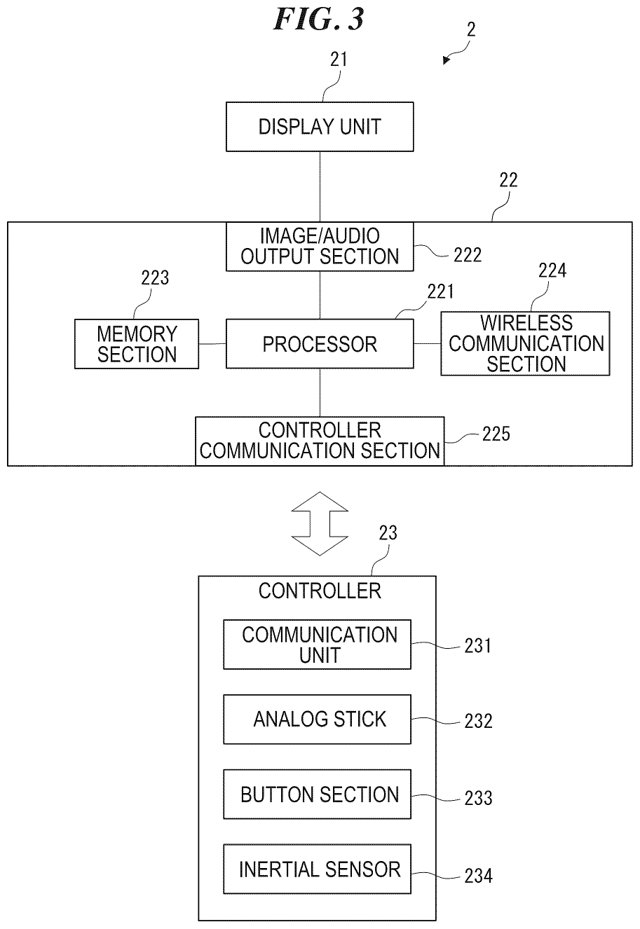

FIG. 3 is a block diagram showing an example of the hardware configuration of a game device in the embodiment of the present disclosure. The game device 2 is equipped with a display unit 21, a main unit 22, and a controller 23. The display unit 21, the main unit 22, and the controller 23 may be integrally configured, or they may be wired or wirelessly connected to each other.

The display unit 21 is a device in which a plurality of pixels are arranged two-dimensionally to perform display based on video signals. The display unit 21 also has a function to output audio based on audio signals. The display unit 21 may be a display panel and speaker integrated with the main unit 22, or may be a monitor device with a speaker (e.g., a TV receiver) that is connected to the main unit 22 by a wire and receives and displays video signals from the main unit 22.

The main unit 22 is equipped with a processor 221, an image/audio output section 222, a memory section 223, a wireless communication section 224, and a controller communication section 225. The memory section 223 stores various programs executed and various data used by the processor 221. The memory section 223 may be an internal storage medium, such as flash memory or DRAM (Dynamic Random Access Memory), for example, or may be configured to use an external storage medium or the like that is attached to a slot not shown.

The processor 221 is an information processing unit that executes various types of information processing performed in the main unit 22, and may, for example, be configured only from a CPU (Central Processing Unit), or may be configured from a SoC (System on Chip) that includes multiple functions such as CPU functions and GPU (Graphics Processing Unit) functions. The processor 221 executes the information processing program (in this embodiment, the game program) stored in the memory section 223 to perform various types of information processing.

The wireless communication section 224 allows the game device 2 to perform wireless communication with other main units 22 and predetermined server devices. For example, Internet communication and short-range wireless communication are used for the wireless communication. The controller communication section 225 allows the main unit 22 to performs wired or wireless communication with the controller 23. The image/audio output section 222 outputs the video and audio signals generated by the processor 221 to the display section 5.

The controller 23 has a vertically shaped housing, which can be grasped in an orientation that is vertical. The housing is shaped and sized so that it can be grasped with one hand when grasped in a vertical orientation.

The controller 23 is equipped with at least one analog stick 232, which is an example of a direction input device. The analog stick 232 can be used as a direction input section capable of inputting directions. By tilting the analog stick 232, the user can input the direction according to the direction of tilt (and the magnitude according to the angle of tilt). The controller 23 is also equipped with a button section 233 that includes various operation buttons. For example, the controller 23 may include a plurality of operation buttons on the main surface of the housing described above. The operation buttons are, for example, an A button, B button, X button, Y button, plus button, minus button, L button, R button, etc.

The controller 23 is also equipped with an inertial sensor 234. Specifically, the controller 23 is equipped with an acceleration sensor and an angular rate sensor as the inertial sensor 234. In the embodiment of the present disclosure, the acceleration sensor detects the magnitude of acceleration along three predetermined axial directions. And the angular rate sensor detects the angular rate around the predetermined three axes.

The controller 23 is also equipped with a communication unit 231 for wired or wireless communicating with the above controller communication section 225. Contents of directional input to the analog stick 232, information indicating the state of pressing the button section 233, and various detection results by the inertial sensor 234 are repeatedly output to the communication unit 231 at appropriate timing and transmitted to the main unit 22.

### [Overview of the Game]

Next, the game processing to be performed in this embodiment is explained. First, an overview of the game assumed in this embodiment is explained. The game assumed in this embodiment is a game in which the player character explores a three-dimensional virtual space under the sea surface (hereinafter referred to as “virtual underwater space” or simply “virtual space”) by diving.

The game may be one in which points are awarded to the user for accomplishing predetermined missions in the process of the player character exploring the virtual underwater space, and the user is ranked according to the points earned, or it may be one in which the player character simply explores the virtual underwater space without setting a specific objective, and records the logs of the exploration.

In this embodiment, the user can participate in the game by joining a session set up by the game server 1. In the session, users of multiple game devices 2 connected online to the game server 1 can simultaneously explore the same virtual underwater space. Instead of or in addition to this, users may be able to play a game in which they explore the virtual undersea space alone. In this case, the game device 2 may be capable of executing such a game offline.

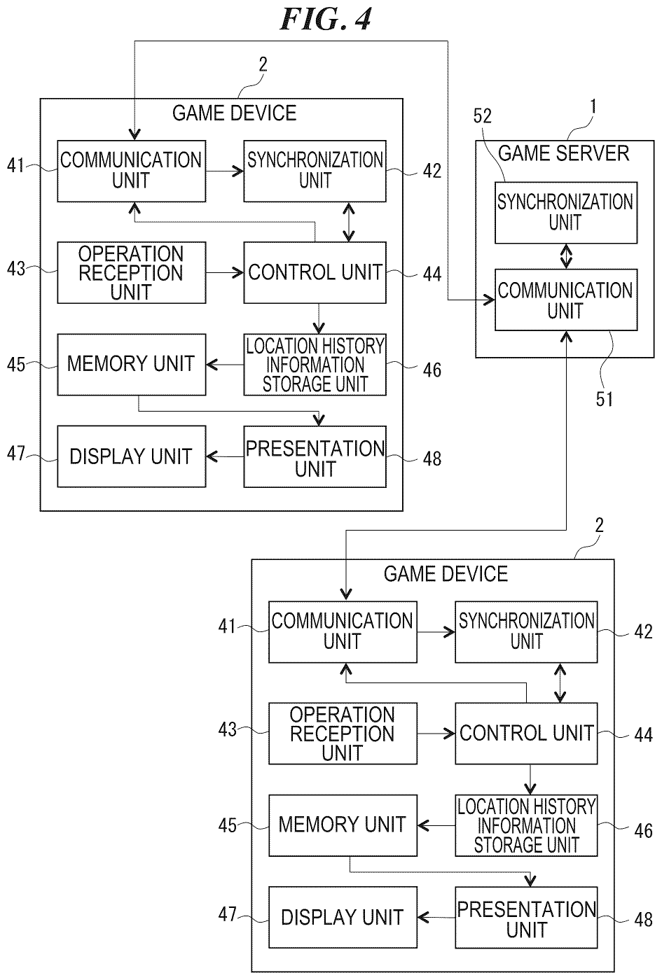

FIG. 4 is a block diagram showing the functional configuration of the information processing system in the embodiment of the prevent disclosure. As described above, the game system 100 as an information processing system includes the game server 1 and the plurality of game devices 2. In FIG. 4, two game devices 2 are shown. In the following, any one of the plurality of game devices 2 comprising the game system 100 is also referred to as a first terminal, and any game device 2 different from the first terminal is also referred to as a second terminal. The game system 100 executes the game in which a game status is synchronized between the first terminal and the second terminal participating in the same session.

The game server 1 is equipped with a synchronization unit 52 for processing for synchronization of the game status between the first terminal and the second terminal, and a communication unit 51 for communicating with the first terminal and the second terminal, respectively. The synchronization unit 52 is composed of the processor 11 of FIG. 2 executing a predetermined program and operating using the memory unit 12, and the communication section 51 corresponds to the communication unit 13 of FIG. 2.

Each game device 2 is equipped with a communication unit 41, a synchronization unit 42, an operation reception unit 43, a control unit 44, a memory unit 45, a location history information storage unit 46, a display unit 47, and a presentation unit 48. These functions are configured in cooperation with the hardware shown in FIG. 3 by processor 221 in FIG. 3 executing the game program as the information processing program of this embodiment. The game program may be stored on a non-transitory storage medium and may be read from the non-transitory storage medium and installed in the game device 2. The game program may also be installed in the game device 2 by the game device 2 downloading it from a server through a communication network.

The configuration of the game device 2 does not need to be all provided on the same device, but may be distributed among multiple devices, in which case the functions described below may be configured by the multiple devices communicating with each other wired or wirelessly. In the following, the functions of the game device 2 as the first terminal are explained.

The communication unit 41 is a configuration corresponding to the wireless communication section 224 shown in FIG. 3, and transmits and receives various information by wired or wireless communication with the game server 1. In particular, the communication unit 41 transmits location history information (hereinafter referred to as the first location history information) about where a player character of the first terminal (hereinafter referred to as the first character) is located in the virtual space to the game server 1 and receives location history information (hereinafter referred to as the second location history information) about where a player character of the second terminal (hereinafter referred to as the second character) is located in the virtual space from the game server 1.

The operation reception unit 43 receives operations by the user on the analog stick 232, the button section 233, and the inertial sensor 234 as electrical signals. In the game, the control unit 44 controls the position of the first character in the virtual space based on the operation input (specifically, the operation on the joystick 232) to move the first character by the user of the first terminal (hereinafter referred to as the first user).

The location history information storage unit 46 stores the first location history information and the second location history information in the memory unit 45. The first location history information is a history of the first character's location in the control unit 44 and is obtained from the control unit 44. The second location history information is a history of the second character's location and is obtained via the communication unit 41. To this end, the synchronization unit 42 synchronizes the game status with the second terminal participating in the same session. Specifically, the synchronization unit 42 transmits the first location history information to the game server 1 via the communication unit 41 and receives the second location history information from the game server 1.

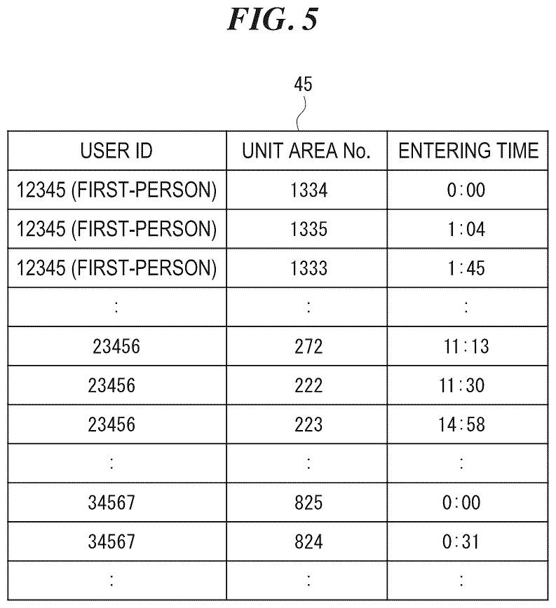

FIG. 5 is a table showing the data structure of the location history information stored in the memory section in the embodiment of the present disclosure. The location history information is information that includes information indicating the location of each user's character in the virtual underwater space at each different time. In this embodiment, as an example, each record of the location history information stored in the memory unit 45 includes the user ID, the area number of the area where the user's character was located, and the time when the character entered the area. In other examples, the user ID and the coordinates in the virtual underwater space where the character of the user was located at each unit of time may be included.

Here, the virtual underwater space is divided into multiple unit areas in the planar direction. The size of the virtual underwater space may be, for example, 500 m×500 m, and the size of the unit area may be, for example, 10 m×10 m. In other words, the virtual underwater space may be divided into (50×50=) 2500 unit areas. Each unit area is assigned an area number, and the location history information indicates the area the character has traveled (entered) with this area number.

The time of entry may be the actual date and time in the country concerned, but in this embodiment, the time of entry is represented by the elapsed time from the start of the session based on the session start time. Users may join a session at the start of a session, or may join a session in the middle of the session after the session has started. When each user joins a session, he/she starts the game from a randomly chosen location in the virtual underwater space. Therefore, an area where each player character is located at time 0:00 is generally different.

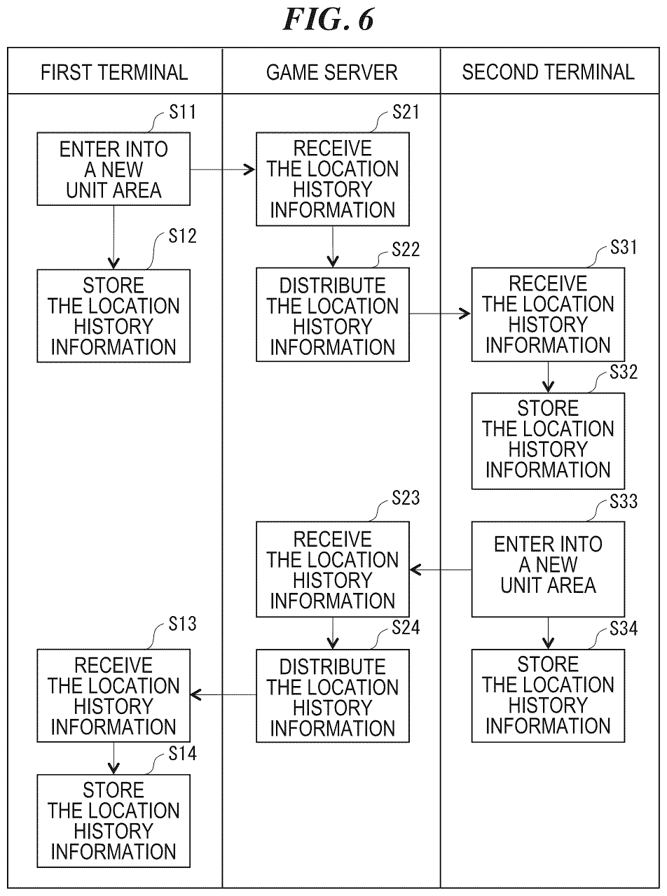

FIG. 6 is a timing chart of the process performed for synchronization between the game server, the first terminal, and the second terminal. When movement control is performed at the first terminal, resulting in entry into a different (adjacent) unit area from the unit area of the current location (step S11), the location history information storage unit 46 stores the area number of the unit area newly entered and its time in the memory unit 45 as location history information (step S12), and transmits the location history information including the user ID of the first terminal, the area number of the unit area entered, and the time of entry into the unit area to the game server 1.

At the game server 1, the synchronization unit 51 receives the location history information transmitted from the first terminal via the communication unit 51 (step S21) and distributes the received location history information to all terminals (including the second terminal) participating in the session at a predetermined timing (step S22). In this embodiment, the location history information is periodically distributed from the game server 1 to each terminal. On the contrary, each terminal may periodically access the game server 1 to obtain the location history information stored in the game server 1.

At the second terminal, the synchronization unit 42 receives the location history information from the game server 1 via the communication unit 41 (step S31), and the location history information storage unit 46 stores this location history information in the memory unit 45 (step S32). This causes a new record of the location history information shown in FIG. 5 to be added in memory unit 45.

When the second terminal performs a movement control in which the second character enters an adjacent unit area from the current location (step S33), the location history information storage unit 46 records the location history information in the memory unit 45 for this entered unit area (step S34) and transmits this location history information to the game server 1.

At the game server 1, as in the case where it received the location history information from the first terminal, the synchronization unit 51 receives the location history information transmitted from the second terminal via the communication unit 51 (step S23), and at a predetermined timing, distributes the received location history information to all terminals (including the first terminal) participating in the session (step S24).

In the first terminal, as in the processing of the second terminal described above, the synchronization unit 42 receives the location history information from the game server 1 via the communication unit 41 (step S13), and the location history information storage unit 46 stores this location history information in the memory unit 45 (step S14). As a result, a new record of the location history information shown in FIG. 5 is added in memory unit 45.

In FIG. 6, the example is illustrated in which the process of sharing the first character's location history information with other terminals including the second terminal (from step S11 to step S32) is followed by the process of sharing the second character's location history information with other terminals including the first terminal (from step S33 to step S14). However, these processes do not have to be in this order, and each can be executed at any timing. The process of distributing the location history information from the game server 1 to multiple terminals is performed periodically. Therefore, the game server 1 acquires the location history information from multiple terminals in intervals of distributing location history information, accumulates the location history information to be shared by all terminals, and distributes the location history information acquired from the multiple terminals to all terminals at the timing of distribution.

The display unit 47 switches between a game screen and a log screen. The game screen is an image from a first character's viewpoint or an image by a virtual camera behind the first character (the screen including the first character). The log screen includes a map image, which is a planar view of the virtual underwater space where the session is being executed. The display unit 47 displays the images presented by the presentation unit 48. The display unit 47 corresponds to the display unit 21 shown in FIG. 3.

The presentation unit 48 generates images to be displayed on the display unit 47 and presents the generated images to the display unit 47. In this embodiment, in particular, the presentation unit 48 presents the log screen including a map image corresponding to the virtual underwater space, when there is an operation by the first user to display the log screen (specifically, the operation pressing a predetermined button of the button section 233). The presentation unit 46 generates the map image by referring to the first location history information and the second location history information stored in the memory unit 45.

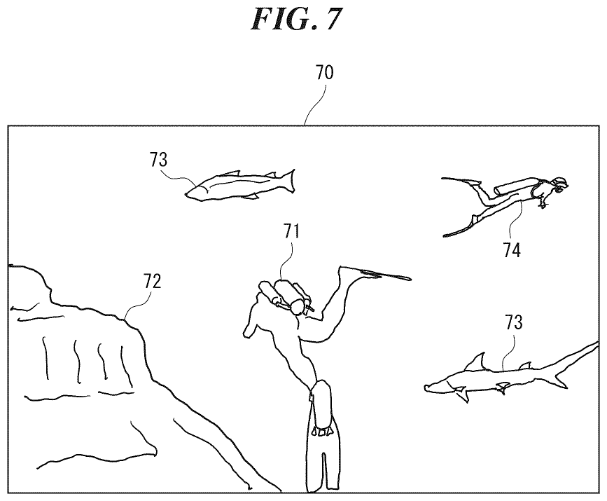

FIG. 7 shows an example of a game screen in the embodiment of the present disclosure. In the game screen 70, the first character 71 swimming in the underwater virtual space is displayed in the center of the screen, with the angle of view as the image taken by the virtual camera behind the first character 71. The game screen 70 also includes the terrain 72 around the first character 71, the creatures 73 and the second character (other player characters) 74 therein in the virtual underwater space. The game screen 70 may display various information about the location, the creatures and the second character in the screen. The game screen may also display an image of a first-person view of the first character.

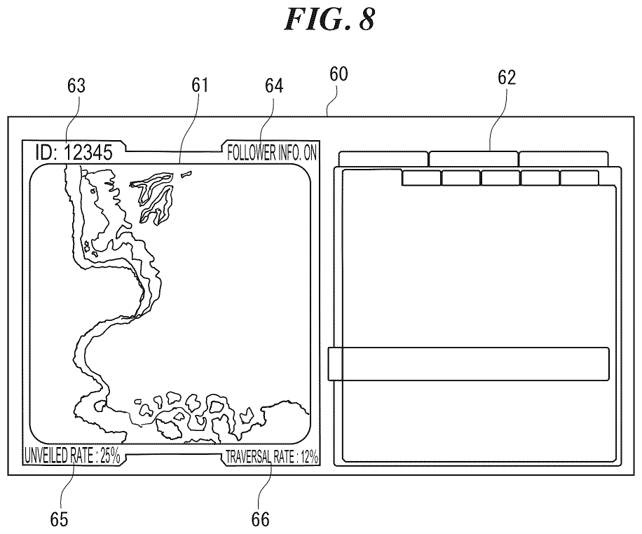

FIG. 8 shows an example of a log screen in the embodiment of the present disclosure. The log screen 60 includes a map image 61 and an information display window 62. Around the map image 61, it is displayed a user ID 63, a display content 64 indicating whether or not there is sharer's information, the unveiled rate 65 indicating the percentage of areas where the player character has taken a predetermined action on the terrain parts and the creatures thein etc. (in this embodiment, the action by the player character to investigate by peeling off bacteria worn by underwater creatures), and the traversal rate 66 indicating the percentage of areas traversed by either the first character or the second character. As shown in FIG. 8, the map image 61 shows contour lines including an outline of sea water level (0 m above sea level), and the area enclosed by the contour lines is colored according to its depth. The “sharer” refers to a second user who shares information in the game with the first user.

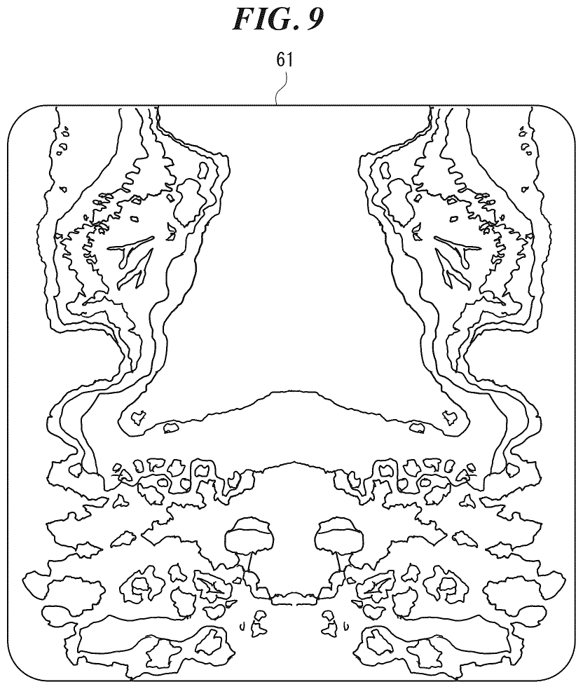

FIG. 9 shows another example of a map image in the embodiment of the present disclosure. The map image 61 in FIG. 9 shows a map of the entire virtual underwater space. Thus, the user can switch between displaying a map showing the entire virtual underwater space or displaying an enlarged map of the surrounding area where the first character is located as the map image 61 in the log screen 60 by operating a predetermined button of the button section 233. The user can also switch the information displayed in the information display window 62 in the log screen 60 by operating a predetermined button of the button section 233. In the information display window 62, in addition to diving logs, sharers and rankings are provided as display categories.

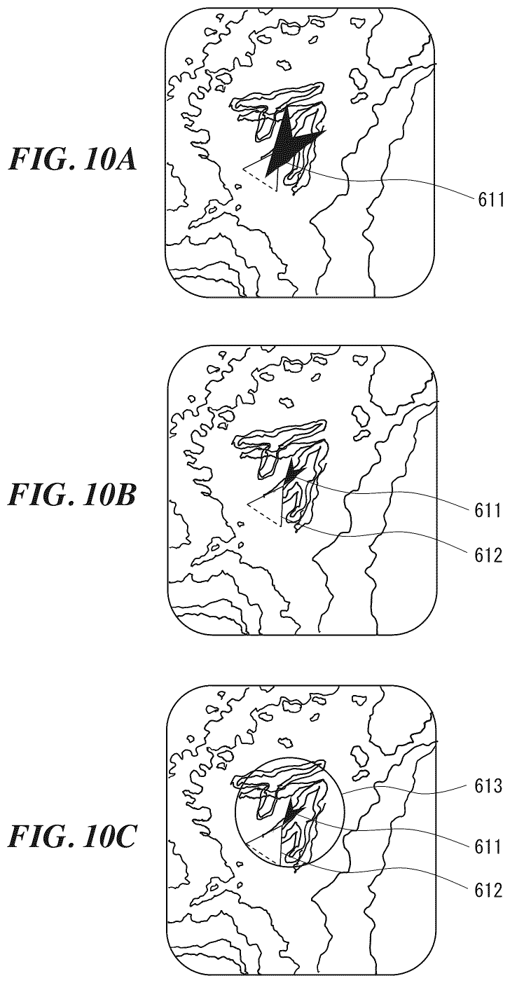

FIGS. 10A to 10C show examples of displaying marks indicating the location of the player character in the map image in the embodiment of the present disclosure. In the map image 61, the location of the first character is indicated by arrowhead mark 611. In front of the arrowhead mark 611 is shown a triangle 612 that extends in the direction the first character is facing.

When displaying the map image 61, the presentation unit 48 animatedly displays the arrowhead mark 611 as a position icon indicating the position of the first character immediately after starting displaying the map image 61, so that the first character's position in the map image is easily visible. Immediately after displaying the map image 61, the presentation unit 48 enlarges and displays the arrowhead mark 611 indicating the position of the first character, as shown in FIG. 10A. The presentation unit 48 then gradually reduces the size of the arrowhead mark 611 and returns it to its original size, as shown in FIG. 10B. The presentation unit 48 further then animates and displays a sonar radar-like light emitting object effect 613 around the arrowhead mark 611, as shown in FIG. 10C.

In this way, when starting displaying the map image 61, the presentation unit 48 animatedly displays an enlarged arrowhead mark 611 indicating the position of the first character, and also animatedly displays the light-emitting object effect 613 afterwards, so that the position of the first character is momentarily visible, and the position of the first character can then be easily and continuously visible.

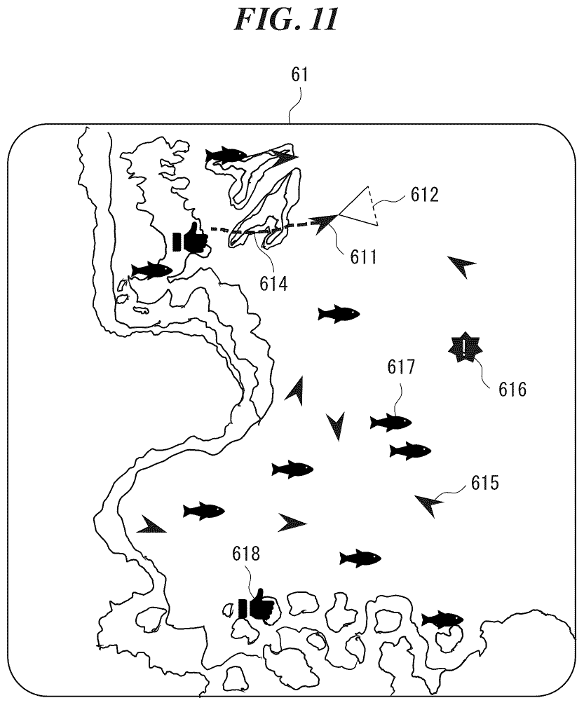

FIG. 11 shows an example of a map image in the embodiment of the present disclosure. The information displayed in the map image 61 is divided into public information that is shared by all characters participating in the session and private information that is only received from the first character or its sharer. The private information includes, for example, arrowhead mark 611 of the first character's position icon, sharer's position icon 615, emote icon 616, and icons of creatures or points marked by the sharer 617. The public information also includes, for example, unknown pulse location information for the first character and its sharer. The trajectory of the first character's movement 614 is also displayed in the map image 61.

Although the details are omitted in FIG. 8, private log information and public log information are displayed as log information in the information display window 62. The private log information includes a sharer's return to the session, a sharer's departure from the session, a sharer's marking (sharing) on the creatures, a sharer's marking (sharing) of coordinates, a sharer's salvage information, and a mission reward distribution log. And public log information includes main mission-related logs, information for map traversal rate, information for the unveiled rate, and other announcements from the system.

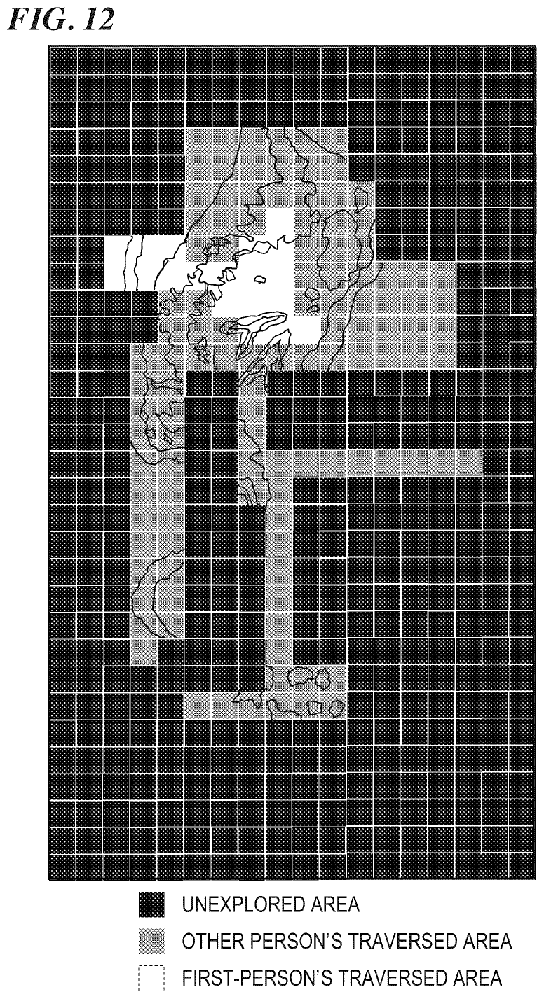

FIG. 12 shows an example of a map image in the embodiment of the present disclosure. Based on the location history information stored in the memory unit 45, the presentation unit 48 shows a map image that can distinguish a person's traversed area corresponding to the location of the virtual underwater space where the first character has been located, an other's traversed area corresponding to the location of the virtual underwater space where the second character has been located but the first character has never been located, and an unexplored area corresponding to the location of the virtual underwater space where none of the player characters participating in the session has ever been located. Specifically, the presentation unit 48 presents the map image in such a way that the first-person's traversed area is displayed in a first display mode, the other's traversed area is displayed in a second display mode, and the unexplored area is displayed in a third display mode.

In the example of FIG. 12, the unexplored area is superimposed with a mask that hides the ground surface of the virtual underwater space (the third display mode), so that information such as the terrain of the unexplored area is not visible in the map image. In the map image of the example in FIG. 12, for the other's traversed area, it is superimposed with a mask that is visible to information such as terrain but transparent (the second display mode). For the first-person's traversed area, it is not masked (the first display mode), and visible to information such as the terrain.

The other's traversed area may be displayed in monotone (the second display mode) instead of masked, so that it can be distinguished from the first-person's traversed area displayed in full color (the first display mode). In other words, the mask panel of the unexplored area is not transparent, and the mask of the other's traversed area may be used to check the terrain, but with less color information than in the first-person's traversed area. In the map image, there is no distinction between areas where only the first character has been located and areas where the first character and the second character have been located, and both are displayed in full color as the first-person's traversed area without being masked.

In the example in FIG. 12, masking is performed by superimposing a mask panel on the map image for each 10 m×10 m unit area, and when a player character enters an unit area, the unit area is changed to a traversed area. As the game progresses, the traversed area will gradually expand as the first and second characters are located in new areas of the virtual underwater space. The presentation unit 48 updates the map image when such an update occurs, even when the map image is being displayed.

When the game screen 70 or the log screen 60 is being displayed, if a parameter indicating the size of the area where the first character and the second character have been located in the virtual underwater space meets a predetermined condition, the presentation unit 48 has a function of presenting a notification to the first user of the first character and the second user of the second character.

Specifically, the presentation unit 48 may, for example, present such a notification every time the traversal rate, which is the ratio of the size of the traversed area to the size of the virtual underwater space, increases by 5%. The presentation unit 48 may also present such a notification every time the first-person's traversal rate increases by 5%. Similarly for the second character, such a notification may be presented for each 5% increase in the second character's first-person's traversal rate. In addition, the above notification may also be made by limiting such a second character to sharers.

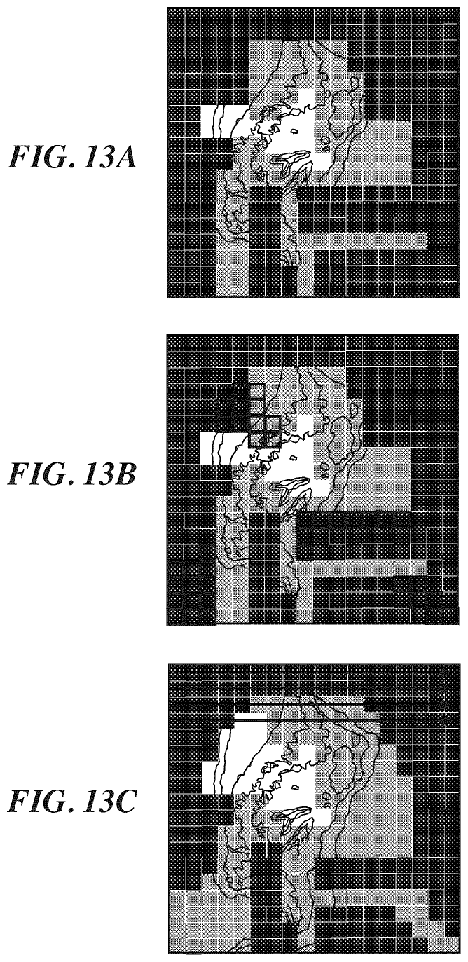

FIGS. 13A to 13C show examples of a map images in the embodiment of the present disclosure. Referring to FIGS. 13A to 13C, the method of displaying the map image when switching from the game screen to the log screen is explained. When the first user performs a predetermined button operation to switch the screen to the log screen 60 while the game screen is displayed, the operation reception unit 43 accepts this operation. Based on this operation, the presentation unit 48 presents the log screen 60 including the map image. In this log screen 60, the presentation unit 48 reads the location history information from the memory unit 45, presents a map image that distinguishes between the first-person's traversed area, the other's traversed area, and the unexplored area based on this location history information, as shown in FIG. 12.

At this time, the presentation unit 48 first presents the map image presented when the previous log screen display operation was performed (hereinafter referred to as the previous map image) as a map image, as shown in FIG. 13A. Then, as shown in FIGS. 13B and 13C, the latest map image (hereinafter referred to as the current map image) is presented through an animation based on the updated location history information during the period from the previous map image presentation to the current log screen display operation. In the example shown in FIG. 13, the mask panel is highlighted for the unit area that was updated between the previous map image and the current map image in FIG. 13B (indicated by the bold frame in FIG. 13B), and then the mask is removed or changed, as shown in FIG. 13C.

For this purpose, the presentation unit 48 stores the time when the previous map image was displayed. If the map image is updated even when the map image is displayed, the time when the previous map image was closed is stored. Then, the presentation unit 48 first displays the previous map image (see FIG. 13A), refers to the location history information in the memory unit 45 shown in FIG. 5, extracts the newly updated content from the previous time to the current time, presents the current map image reflecting the latest location history information (see FIG. 13C). At this time, as shown in FIG. 13C, the animation process of mask change and removal is performed sequentially from the upper left unit area to the right and down the line. The animation process of mask change and removal may be performed in the order of the unit areas traversed by the character, or all unit areas to be updated may be updated simultaneously without animation processing.

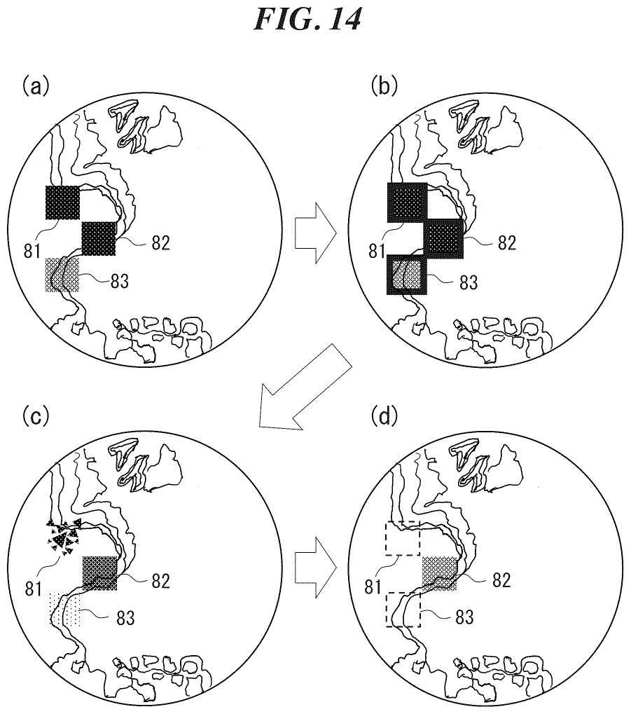

FIG. 14 shows an example of map images in the embodiment of the present disclosure. With reference to FIG. 14, the animation of presenting the current map image progressively from the previous map image is explained in detail. In FIG. 14, unit area 81 is the unexplored area last time and has been updated to the first-person's traversed area this time, unit area 82 is the unexplored area last time and has been updated to the other's traversed area this time, and unit area 83 is the other's traversed area last time and has been updated to the first-person's traversed area this time.

The unit area 81 is masked by a non-transparent mask panel in the previous map image (see (a) in FIG. 14). The mask panel is then highlighted (see (b) in FIG. 14), an animation of the mask panel being destroyed is displayed (see (c) in FIG. 14), and the mask panel is removed in the current map image (see (d) in FIG. 14). The unit area 82 is masked by a non-transparent mask panel in the previous map image (see (a) in FIG. 14). The mask panel is then highlighted (see (b) in FIG. 14), the mask panel gradually becomes translucent (see (c) in FIG. 14), and is masked by a mask panel with transparency in the current map image. The unit area 83 is masked by the mask panel having transparency in the previous map image (see (a) in FIG. 14). The mask panel is then highlighted (see (b) in FIG. 14), the mask panel gradually becomes thinner (see (c) in FIG. 14), and the mask panel is removed in the current map image (see (d) in FIG. 14).

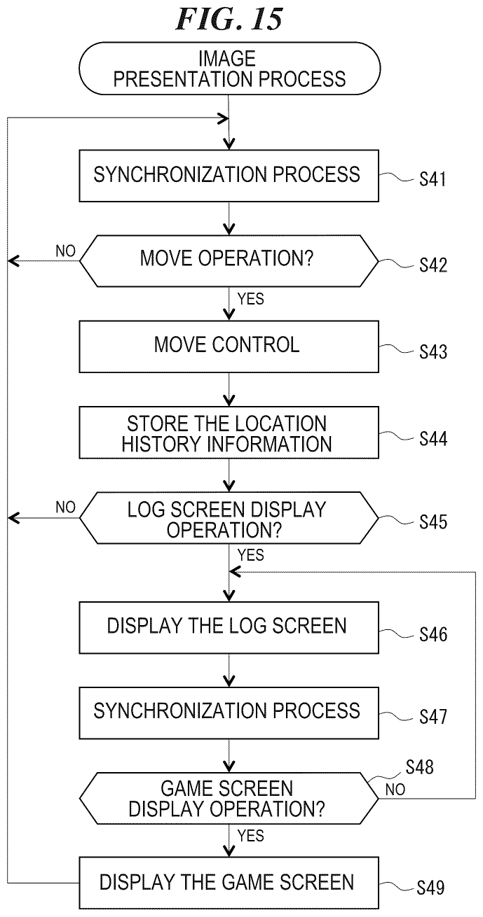

FIG. 15 is a flowchart of the screen presentation process in the embodiment of the present disclosure. The screen presentation process is executed at the first terminal. First, the synchronization unit 42 performs synchronization processing (step S41). In the synchronization processing, the first location history information is transmitted to the game server 1, and the second location history information is acquired from the game server 1 and stored in the memory unit 45. Next, the operation reception unit 43 monitors whether a move operation to move the first character is input or not (step S42), and if no move operation is input (NO in step S42), the synchronization process is repeated back to step S41.

If there is a move operation (YES in step S42), the control unit 44 controls the movement of the first character according to the move operation (step S43). The location history information storage unit 46 stores the first location history information in the memory unit 45 in response to the movement control (step S44). Next, the operation reception unit 43 determines whether or not a log screen display operation to display the log screen 60 is received (step S45). If there is no log screen display operation (NO in step S45), the process returns to step S41 and the above process is repeated.

If there is a log screen display operation (YES in step S45), the presentation unit 48 presents the log screen 60 (step S46). At this time, an animation reflecting the difference (updated contents) from the previous map image to the current map image is displayed as described above in the map image. Even while the log screen 60 including the map image 61 is being displayed, the synchronization unit 42 continues synchronization (step S47). Then, the operation reception unit 43 monitors whether or not a game screen display operation to switch the screen from the log screen 60 to the game screen 70 has been accepted (step S48).

If the game screen display operation is not accepted (NO in step S48), the presentation unit 48 returns to step S46 and continues to present the log screen 60. If the game screen display operation is accepted (YES in step S48), the presentation unit 48 presents the game screen 70 (step S49) and returns to step S41 to repeat the above process.

As described above, according to the information processing system 100 in the embodiment, in the game in which player characters of multiple game devices 2 participate in the same session, each game device 2 is presented with the map image such that it can distinguish areas in which its own character has been located from areas in which other characters have been located, thereby it is possible to improve the visibility of each area.

In addition, since the information processing system 100 of this embodiment presents a map image to be presented this time (the current map image) after presenting a map image presented last time (the previous map image) when presenting a map image as log information, the user can recognize the areas where his/her character and other characters have been located during the period between the presentation of the previous map image and the presentation of the current map image.

In the information processing system 100 of the above embodiment, a virtual underwater space is provided as a virtual space, but the virtual space is not limited to this and may be a virtual space on the ground or in the air. And in the above embodiment, the information processing system 100 presents the virtual space and its map images in the course of executing a game as a game system, but the information processing system 100 is not limited to those applied to games, and for example, it may be a system that executes a driving simulation of a vehicle, drone, or other moving object.

In the above embodiment, the virtual space is provided as a three-dimensional space, while the location history information is presented in a two-dimensional unit area, and a flat map image 61 with no information in the height (depth) direction was presented in the log screen 60. The location history information storage unit 46 determines that the player character is located (entered) the unit area if the player character is located at any height of the unit area, and performs the above process.

When determining the traversal rate 66 and the unveiled rate 65 (see FIG. 8), the number of unit areas that can be traversed (the mother number when determining the traversal rate) may be determined in the following manner. That is, when a 3D virtual space is generated for each session by combining multiple randomly selected existing terrain parts at randomly selected depths, the maximum number of unit areas determined for each terrain part is calculated. For example, if one terrain part is 100 m×100 m in size and the unit area is 10 m×10 m, the maximum number of unit areas for this terrain part is calculated to be 10×10=100.

Then, the number of unit areas that can be entered (traversed) is determined, for example, if sunk every 5 meters. For example, it is impossible to enter a unit area that is out of the ground. In this case, whether it is possible to enter or not may be determined by a counting function that counts the areas that could be entered by actually moving the character. By using this counting function, the unit area that can be entered can be accurately counted even in a 3D virtual space generated by combining multiple existing randomly selected terrain parts at randomly selected depths.

In this way, since the number of unit areas that can be entered can be determined from the height (depth) of the terrain parts in a randomly generated 3D virtual space, for the multiple terrain parts comprising a 3D virtual space, the number of such enterable unit areas added together can be determined as the total number of enterable unit areas in the session.

Even in areas such as caves, which are considered above the ground in a two-dimensional perspective, it may be possible to pass under it and move to the central lake. In such cases, the number of unit areas that can actually be entered can be counted using the counting method with the counting function described above. The number of unit areas that can be entered may be determined by human counting without using this counting function.

In the above embodiment, the presentation unit 48 presents the map image 61 as log information, and this map image 61 shows the terrain of the three-dimensional virtual space. But the presentation unit 48 may be able to present an un-unveiled distribution map image in addition to this map image 61. The un-unveiled distribution map image is map information that visualizes the number of creatures that have not yet been unveiled for each unit area.

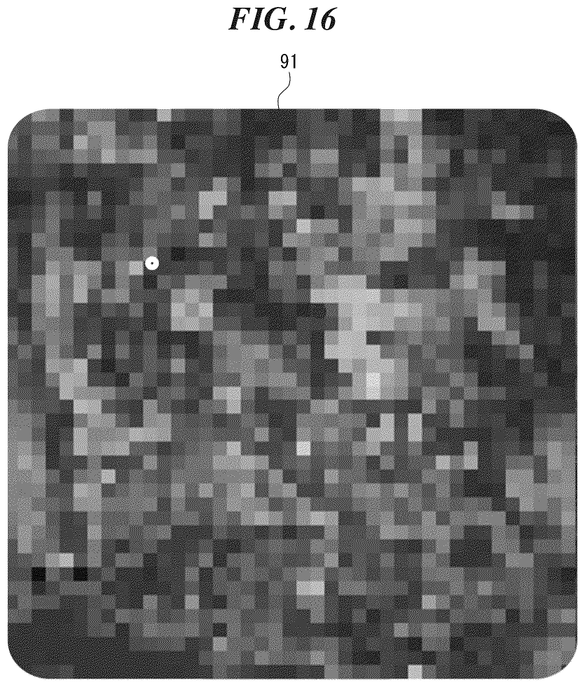

FIG. 16 shows an example of an un-unveiled distribution map image in the embodiment of the present disclosure. In the un-unveiled distribution map image 91, the amount of un-unveiled creatures is expressed by color for each unit area. In the example in FIG. 16, the un-unveiled distribution map image is displayed in black and white, with lighter colors indicating a greater number of un-unveiled creatures. The un-unveiled distribution map image may be displayed in color, with more un-unveiled creatures displayed in red, and fewer un-unveiled creatures are displayed in blue for each unit area.

We claim:

1. A non-transitory storage medium having stored therein an information processing program executed by a computer of a first terminal capable of executing a game in which a game status is synchronized with a second terminal participating in a same session, causing the computer to function as:
a controller configured to control a location of a first character in a virtual space in the game based on a first operation input by a first user of the first terminal;
a location history information storing section configured to store in a memory unit location history information indicating where each of a second character whose location in the virtual space is controlled based on an operation input by a second user of the second terminal and the first character has been located in the virtual space in the game; and
a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

2. The non-transitory storage medium according to claim 1, wherein the presentation section is configured to present the map image so that the first area is presented in a first display mode and the second area is presented in a second display mode, and to present the map image so that it is presented in the first display mode for areas where both the first character and the second character have been located.

3. The non-transitory storage medium according to claim 1, further causing the computer to function as:
a notification presenting section configured to present a notification to a first user of the first character and a second user of the second character, when a parameter indicating a size of an area in the virtual space in which the first character and the second character have been located in the virtual space meets a predetermined condition.

4. The non-transitory storage medium according to claim 1, wherein the presentation section is configured to mask areas in the virtual space where the first character has not been located, and to reveal areas in the virtual space where the first character has been located by removing masks in areas in the virtual space where the first character has been located.

5. The non-transitory storage medium according to claim 4, wherein the presentation section is configured to mask areas in the virtual space where the first character has not been located with different masks for a third area where the second character has been located and a fourth area where the second character has not been located.

6. The non-transitory storage medium according to claim 5, wherein the presentation section is configured to perform a first mask that reduces color information of ground surface in the third area and a second mask that superimposes a mask panel that hides ground surface in the fourth area.

7. A non-transitory storage medium having stored therein an information processing program executed by a computer of a terminal capable of executing a game, causing the computer to function as:
a controller configured to control a location of a first character in a virtual space based on a first operation input by a user of the terminal;
a location history information storing section configured to store location history information indicating location of the first character in the virtual space at each time interval in a memory unit; and
a presentation section configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

8. The non-transitory storage medium according to claim 7, further causing the computer to function as a section configured to synchronize a game status with other terminals participating in a same session,
wherein the location history information includes information indicating a location in the virtual space at each different time for a second character of the other terminals.

9. The non-transitory storage medium according to claim 8, wherein the presentation section is configured to present the map image in a manner that enables distinguishing, based on the location history information, between a first area where the first character has been located and a second area where the second character has been located.

10. The non-transitory storage medium according to claim 7, wherein the presentation section is configured to present the map image such that after presenting the previous map image, the current map image is presented progressively.

11. The non-transitory storage medium according to claim 10, wherein the presentation section is configured to present the map image masked to areas where the first character has not been located based on the location history information, and to shift the masked image to the current map image by progressively unmasking the mask in the previous map image, for areas where the first character has been newly positioned during the period between a previous second operation input and a current second operation input, based on the location history information.

12. An information processing device as a first terminal capable of executing a game in which a game status is synchronized with a second terminal participating in a same session, comprising:
a controller configured to control a location of a first character in a virtual space in the game based on a first operation input by a first user of the first terminal;
a location history information storing section configured to store in a memory unit location history information indicating where each of a second character whose location in the virtual space is controlled based on an operation input by a second user of the second terminal and the first character has been located in the virtual space in the game; and
a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

13. An information processing device provided on a terminal capable of executing a game, comprising:
a controller configured to control a location of a first character in a virtual space based on a first operation input by a user of the terminal;
a location history information storing section configured to store location history information indicating location of the first character in the virtual space at each time interval in a memory unit; and
a presentation section configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

14. An information processing method executed by a first terminal capable of executing a game in which a game status is synchronized with a second terminal participating in a same session, comprising:
a control step configured to control a location of a first character in a virtual space in the game based on a first operation input by a first user of the first terminal;
a location history information storing step configured to store in a memory unit location history information indicating where each of a second character whose location in the virtual space is controlled based on an operation input by a second user of the second terminal and the first character has been located in the virtual space in the game; and
a presentation step configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

15. The information processing method according to claim 14, wherein the presentation step is configured to present the map image so that the first area is presented in a first display mode and the second area is presented in a second display mode, and to present the map image so that it is presented in the first display mode for areas where both the first character and the second character have been located.

16. The information processing method according to claim 14, further comprising a notification presenting step configured to present a notification to a first user of the first character and a second user of the second character, when a parameter indicating a size of an area in the virtual space in which the first character and the second character have been located in the virtual space meets a predetermined condition.

17. The information processing method according to claim 14, wherein the presentation step is configured to mask areas in the virtual space where the first character has not been located, and to reveal areas in the virtual space where the first character has been located by removing masks in areas in the virtual space where the first character has been located.

18. An information processing method executed on a terminal capable of executing a game, comprising:
a first control step configured to control a location of a first character in a virtual space based on a first operation input by a user of the terminal;
a location history information storing step configured to store location history information indicating location of the first character in the virtual space at each time interval in a memory unit; and
a presentation step configured to present a map image corresponding to the virtual space based on a second operation input by the user, wherein the map image is visible of locations where the first character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.

19. An information processing system capable of executing a game in which a game status is synchronized between a second terminal and a first terminal participating in a same session, comprising:
a controller configured to control a location of a first character in a virtual space in the game based on a first operation input by a first user of the first terminal;
a location history information storing section configured to store in a memory unit location history information indicating where each of a second character whose location in the virtual space is controlled based on an operation input by a second user of the second terminal and the first character has been located in the virtual space in the game; and
a presentation section configured to present a map image corresponding to the virtual space when there is a second operation input from the first user, wherein the map image is distinguishable between a first area corresponding to a location in the virtual space where the first character has been located and a second area corresponding to a location in the virtual space where the second character has been located, based on the location history information.

20. An information processing system including a terminal capable of executing a game, comprising:
a controller configured to control a location of a character in a virtual space based on a first operation input by a user of the terminal;
a location history information storing section configured to store location history information indicating location of the character in the virtual space at each time interval in a memory unit; and
a presentation section configured to present a map image corresponding to the virtual space based on a second operation input by the user, wherein the map image is visible of locations where the character has been located in the past in the game based on the location history information, and to present, when there is the second operation input, a previous map image presented at a time of a previous second operation input as the map image and then present a current map image based on the location history information during the period from when the previous map image was presented until a current second operation input is received as the map image.
